(19) United States
(12) Patent Application Publication
(10) Pub. No.: US 2026/0211926 A1
(43) Pub. Date: Jul. 23, 2026

(54) Reducing Computational Burden in a Generative Model through Target Vocabulary Constraints

(71) Applicant: Microsoft Technology Licensing, LLC, Redmond, WA (US)

(72) Inventors: Kushal DAVE, Milpitas, CA (US); Amit Kumar Rambachan SINGH, Bangalore (IN); Akash Kumar MOHANKUMAR, Bengaluru (IN); Manik VARMA, New Delhi (IN); Jian JIAO, Bellevue, WA (US); Gaurav SINHA, Bangalore (IN); Ravisri Kumara VALLURI, Hyderabad (IN)

(73) Assignee: Microsoft Technology Licensing, LLC, Redmond, WA (US)

(21) Appl. No.: 19/032,585

(22) Filed: Jan. 21, 2025

(51) Int. Cl. G06F 16/338; G06F 40/284

(52) U.S. Cl. CPC G06F 16/338; G06F 40/284

(57) ABSTRACT

A technique generates a response based on a query using a generative model. The technique includes encoding the query into a shortlist embedding and a sequence of response-part embeddings. The technique uses the shortlist embedding to identify a reduced-size vocabulary that is relevant to the query, selected from a larger target vocabulary of tokens. The technique then identifies at least one group of ranked tokens associated with a corresponding response-part embedding. The group of ranked tokens is selected from the reduced-size vocabulary. The technique then constructs a part of a response in a manner that is constrained by the group of ranked tokens. Such constraint helps reduce computational burden and latency. Some implementations construct the response non-autoregressively in a single pass, while others perform this operation autoregressively in plural passes. Some implementations of the target vocabulary include plural-word tokens, each including two or more words.

### BACKGROUND

Generative machine-trained models are now capable of producing high-quality responses to input queries. For instance, a generative model is capable of producing at least one document identifier that correctly identifies a document that is relevant to a query. A retrieval engine uses that document identifier to access the document.

The operations performed by some generative models, however, are computationally expensive. For example, an autoregressive generative model builds a response in token-by-token fashion in plural passes. These operations consume a significant amount of resources and/or can increase the latency at which the model generates its response. These factors, in turn, decrease the applicability of generative models. For instance, a generative model with relatively high latency may be unsuitable for an application that demands real-time responses to input queries.

### SUMMARY

A technique is described herein for generating a response based on a query using a generative model. In some implementations, the technique relies on a language model to encode the query into embedding information. The technique maps part of the embedding information into a reduced-size vocabulary that is relevant to the query, selected from a larger target vocabulary of tokens. The technique constructs the response based on the tokens in the reduced-size vocabulary, rather than the more encompassing larger target vocabulary. This constraint placed on the target vocabulary reduces the number of token possibilities that need to be considered in constructing the response, which, in turn, reduces the amount of computations that the technique performs in this operation. This constraint also reduces the latency in generating the response.

In some implementations, the embedding information includes a shortlist embedding (also referred to herein as vocabulary-guiding embedding) and a sequence of response-part embeddings. The technique produces the reduced-size vocabulary based on the shortlist embedding. The technique constructs each part of the response by drawing from a particular group of ranked tokens. The group of ranked tokens is associated with a particular response-part embedding and is selected from the reduced-size vocabulary.

In some implementations, the technique produces the parts of the query non-autoregressively in a single pass. In other implementations, the technique produces the parts of the response autoregressively in plural passes. The non-autoregressive implementation helps to further reduce the latency in generating responses because it eliminates the iterative processing performed by the autoregressive implementation.

In some implementations, the technique generates the response using a target vocabulary that includes plural-word tokens, each of which includes two or more words (e.g., a common phrase). The use of plural-word tokens is particularly helpful in the non-autoregressive implementation because the plural-word tokens capture inter-word dependencies that are lost in the parallel generation of the parts of the response (compared to the iterative generation of the tokens in the autoregressive mode). The use of plural-word tokens increases the overall size of the target vocabulary. However, this increased size does not unduly increase the computational burden placed on the generative model because it is counteracted by the vocabulary constraints placed on the generation of the response, as summarized above.

The above-summarized technology is capable of being implemented in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

FIG. 1 shows a response-generating system for mapping a query into a response.

FIG. 2 shows one implementation of a reduced-size (RS) vocabulary identifier component, which is part of the response-generating system of FIG. 1.

FIG. 3 shows an example of the operation of the RS vocabulary identifier component of FIG. 2.

FIG. 4 shows one implementation of an ordered set generator, which is another part of the response-generating system of FIG. 1.

FIG. 5 shows an example of the operation of a token selector, which is another part of the response-generating system of FIG. 1.

FIG. 6 shows an example of the end-to-end processing of a query using the response-generating system of FIG. 1.

FIG. 7 shows a non-autoregressive implementation of the response-generating system of FIG. 1.

FIG. 8 shows an autoregressive implementation of the response-generating system of FIG. 1.

FIG. 9 shows a vocabulary-building component that builds a target vocabulary of tokens for use by the response-generating system of FIG. 1.

FIG. 10 shows one implementation of the vocabulary-building component of FIG. 9.

FIG. 11 shows a training system for training parts of the response-generating system of FIG. 1.

FIG. 12 shows a transformer language model for implementing parts of the response-generating system of FIG. 1.

FIG. 13 is a flowchart that provides an overview of one manner of operation of the response-generating system of FIG. 1.

FIG. 14 is a flowchart that provides an overview of another manner of operation of the response-generating system FIG. 1.

FIG. 15 shows computing equipment that, in some implementations, is used to implement the response-generating system of FIG. 1.

FIG. 16 shows an illustrative type of computing system that, in some implementations, is used to implement any aspect of the features shown in the foregoing drawings.

The same numbers are used throughout the disclosure and figures to reference like components and features.

### DETAILED DESCRIPTION

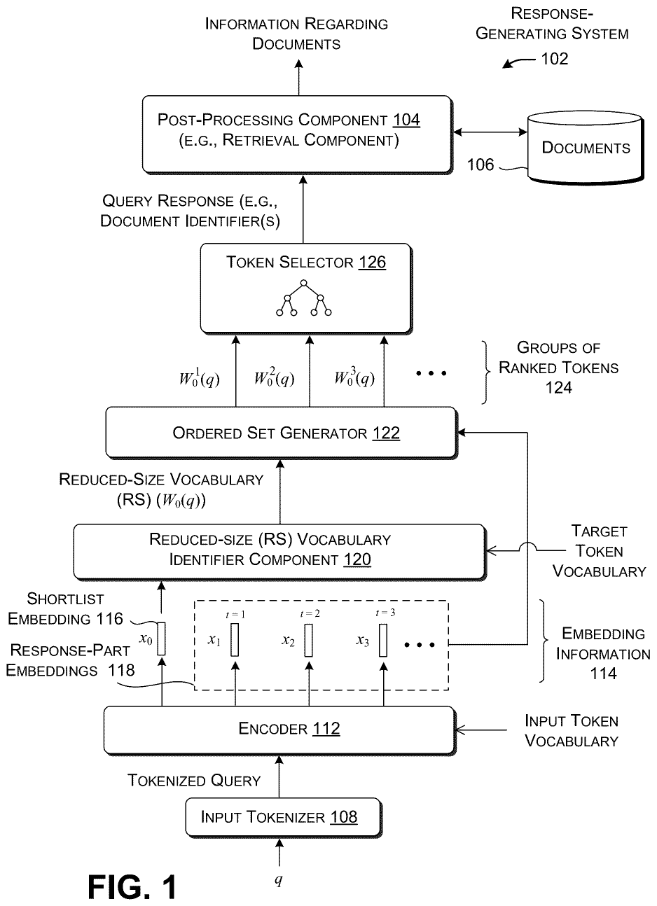

FIG. 1 shows a response-generating system 102 for mapping a query q into a response. A post-processing component 104 performs any application-specific function based on the response. In some implementations, for instance, the response produced by the response-generating system 102 includes one or more document identifiers that identify one or more respective documents. The post-processing component 104 accesses the document(s) based on the document identifier(s), and then generates output information that contains information extracted from the document(s), or the document(s) themselves.

The post-processing component 104 uses any technique to access a document. Assume, for instance, that the response-generating system 102 generates a particular document identifier. The post-processing component 104 performs a lexical lookup operation by finding the document in a data store 106 that is associated with the same document identifier. Alternatively, the post-processing component 104 performs a vector-based lookup operation to find a document in the data store 106 that is closest to the document identifier in a vector space, e.g., as assessed using a cosine similarity metric.

The document identifiers and associated documents have different meanings in different applications. In some applications, for instance, the response-generating system 102 converts the input query q into one or more rephrased queries. The post-processing component 104 represents a search engine that performs a search having any scope based on the rephrased query(ies). In other applications, the post-processing component 104 is a digital assistant, such as web-accessible BOT. The digital assistant finds one or more answers to a user's input query q based on the rephrased query(ies). In other applications, the response-generating system 102 converts the input query into one or more advertisement identifiers, such as keyword information. Here, the post-processing component 104 is an advertising platform that finds one or more digital advertisements that are related to the advertisement identifier(s).

In other implementations, the response produced by the response-generating system 102 itself constitutes the final information that is being sought, without the need for performing a lookup operation. For example, assume that the response includes one or more query reformulations. A search engine presents these query reformulations to the user as query suggestions, any one of which a user may choose to invoke in a follow-up search. Alternatively, assume that the response includes one or more answers to a user's question. A digital assistant presents the answers to the user without performing a lookup operation.

The above applications are representative. Other implementations apply the replying-generating system 102 to other application tasks. In general, assume that the response is expressed using the tokens of an output or target vocabulary V. Further assume that the query is first tokenized using the tokens of an input vocabulary. In the examples below, the target vocabulary differs from the input vocabulary, although these two vocabularies could be the same.

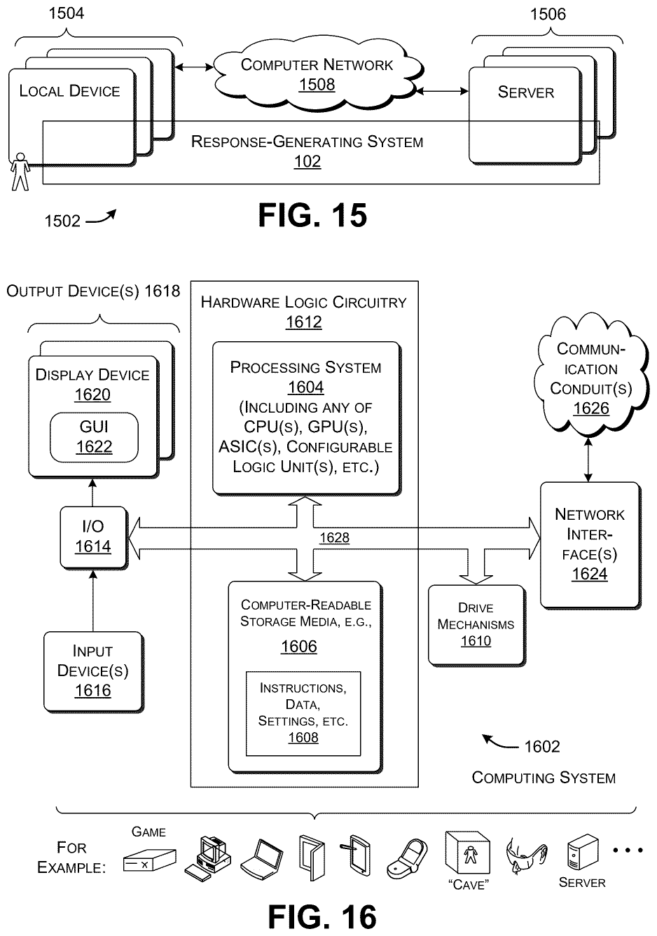

The features of FIG. 1 will be explained in Section A in generally a bottom-to-top manner. Later sections provide further details regarding individual aspects of the response-generating system 102. The following terminology is relevant to some examples presented below. A “machine-trained model” or “model” refers to computer-implemented logic for executing a task using machine-trained weights that are produced in a training operation. A “weight” refers to any type of parameter value that is iteratively produced by the training operation. A “token” refers to a unit of information processed by a machine-trained model, such as a word or a part of a word. In some cases, a tokenizer produces the tokens, but an item (e.g., a text passage) is said to be composed of tokens in a general sense (in which “token” is a synonym of “part”), irrespective of when and where those tokens are actually produced. A “distributed vector” expresses the semantic content of an information item by distributing information over its k dimensions. A token parameter vector is a distributed vector associated with a particular token. In some contexts, terms such as “component,” “module,” “engine,” and “tool” refer to parts of computer-based technology that perform respective functions. FIGS. 15 and 16, described below, provide examples of illustrative computing equipment for performing these functions.

### A. Overview of the Response-Generating System

This section introduces some aspects of the response-generating system 102 in the illustrative context of a non-autoregressive mode of operation, in which the tokens of a response are generated in parallel in a single pass. However, the response-generating system 102 can be modified for an autoregressive mode of operation, in which the tokens of the response are generated in plural passes, one token at a time. The autoregressive mode of operation is described further in connection with the explanation of FIG. 8.

An input tokenizer 108 partitions the input query q into a sequence of input tokens selected from an input vocabulary, to produce a tokenized query. In some implementations, the tokenizer 108 optionally prepends a special classifier token “CLS” to the beginning of these input tokens. The CLS token maps to a predetermined fixed code, and serves as a vehicle for capturing information pertaining to the tokenized query as a whole when transformed by an encoder (to be described below). The tokens in the input vocabulary can be produced by any technique, including byte pair encoding (BPE), the WordPiece algorithm, the SentencePiece algorithm, etc. The tokens in the input vocabulary may include any parts of words, whole words, and plural-word sequences.

An encoder 112 maps the tokenized query into embedding information 114. The embedding information 114 includes a shortlist embedding 116, also referred to herein as a vocabulary-guiding embedding. The embedding information 114 also includes a sequence of s response-part embeddings 118, where s is the sequence length. The shortlist embedding 116 is denoted by x₀(q) and each response-part embedding is denoted by xₜ(q), where t refers to the position of a particular response-part embedding in the sequence of response-part embeddings 118. In some implementations, the encoder 112 produces the shortlist embedding 116 by transforming the CLS token. The encoder 112 produces the response-part embeddings 118 based on tokenized query as a whole. In some implementations, the encoder 112 is a machine-trained language model, such as a transformer language model operating as an encoder. General background information on one type of transformer language model is provided in Devlin, et al., “BERT: Pre-training of Deep Bidirectional Transformers for Language Understanding,” arXiv, arXiv:1810.04805v2 [cs.CL], May 24, 2019, 16 pages. One variation of the BERT model is the DeBERTa model. Additional information regarding transformer language models is provided in Section D below.

A reduced-size (RS) vocabulary identifier component 120 maps the shortlist embedding x₀(q) 116 into a reduced-size (RS) vocabulary of tokens W₀(q), also referred to as a shortlist vocabulary. The RS vocabulary of tokens W₀(q) contains tokens selected from the full target vocabulary V from which the response will be constructed. The target vocabulary includes at least some plural-word tokens. A plural-word token is a token that is composed of two or more words. The phrase “what is the weather in” is an example of a plural-word token. The target vocabulary also includes some single-word tokens, and, optionally, partial-word tokens. A single-word token includes a single word, while a partial word token includes part of a word. Section B below provides information regarding one approach to building the target vocabulary. In some implementations, the full target vocabulary V is relatively large, e.g., encompassing over 5 million tokens.

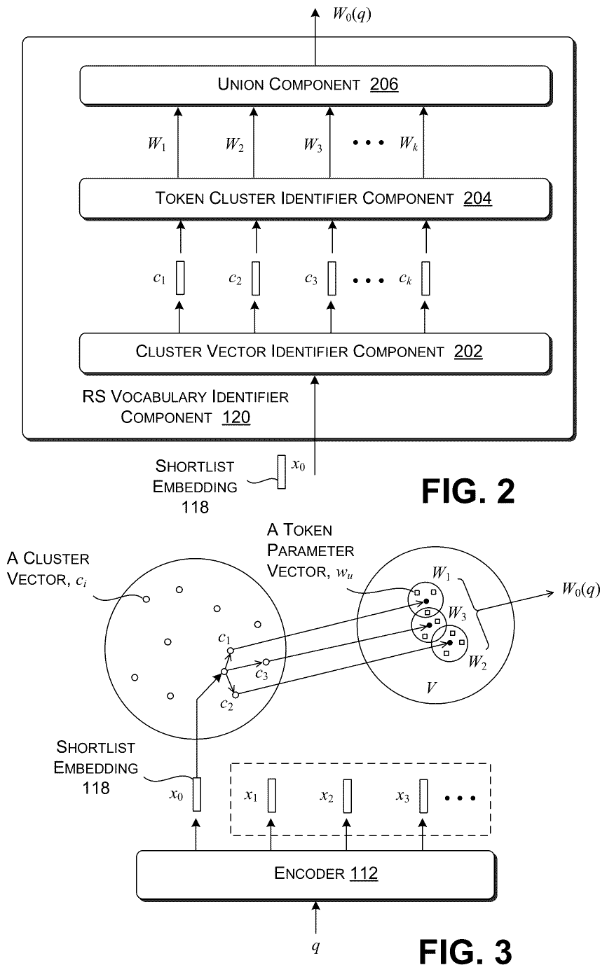

One process for generating the RS vocabulary of tokens W₀(q) is described below with reference to FIGS. 2 and 3. As a preview of that description, the RS vocabulary identifier component 120 finds one or more cluster vectors (c₁, c₂, . . . , cₖ) that are closest to the shortlist embedding x₀(q) 116 in a vector space, selected from among cₘ learned cluster vectors. As an outcome of an offline process performed in advance, each cluster vector is associated with a cluster of tokens having token parameter vectors that are closest to each cluster vector. Each token parameter vector is denoted by wᵤ, and the clusters of tokens associated with the cluster vectors are denoted by W₁, W₂, . . . , Wₖ. The RS vocabulary identifier component 120 then forms the union of these clusters of tokens, which provides the RS vocabulary of tokens W₀(q) from which the response will be constructed.

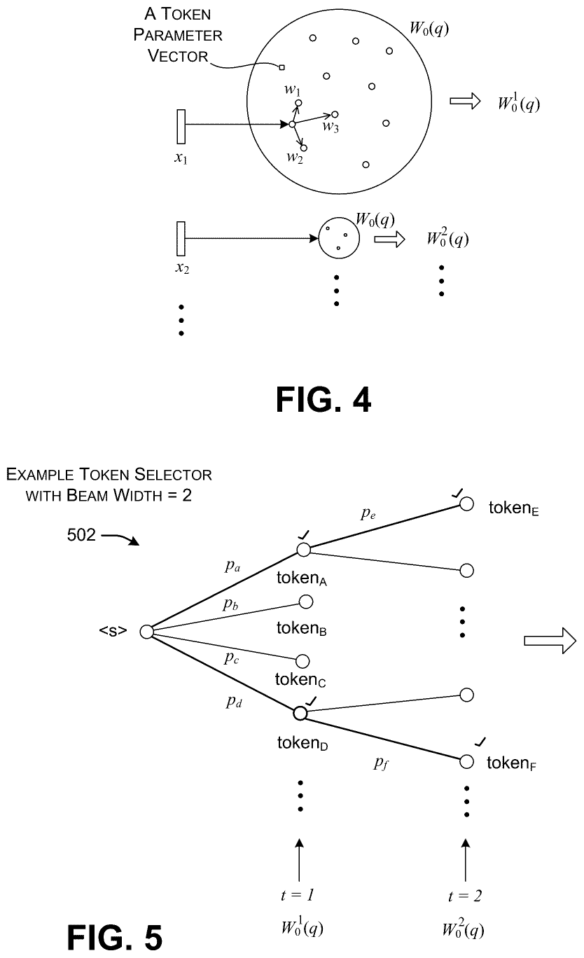

An ordered set generator 122 produces groups of ranked tokens 124 for use in building parts of the response. One process of generating the groups of ranked tokens 124 is described below with reference to FIG. 4. As a preview of that description, the ordered set generator 122 produces each group of ranked tokens for each response-part embedding by finding those tokens having token parameter vectors that are closest to the response-part embedding in a vector space. The tokens in the group are selected from the RS vocabulary of tokens W₀(q). Each group of ranked tokens is referred to as

$${W}_{0}^{t} ( q ) ,$$

in which the superscript t denotes a position in the sequence of response-part embeddings 118, and the subscript 0 indicates that the group of ranked tokens is drawn from the RS vocabulary of tokens W₀(q). The tokens in each ranked group are ordered based on their likelihood of occurrence in the response. Each token in a ranked group of tokens is represented by a token parameter vector wᵤ.

A token selector 126 constructs a response, as guided by the groups of ranked tokens 124. For instance, when interpreting a first part of the response (for t=1), the token selector 126 draws from the group of ranked tokens

$${W}_{0}^{1} ( q )$$

that is associated with this position. In one implementation, the token selector 126 performs its function using a constrained beam search technique. Additional information regarding this implementation is provided below in connection with the explanation of FIG. 5.

As will be described with reference to FIG. 15, the functions of the response-generating system 102 are entirely implemented by a local device, or entirely implemented by one or more servers, or distributed between local and server-side execution platforms in any manner.

FIG. 2 shows one implementation of a RS vocabulary identifier component 120, which produces the RS vocabulary of tokens W₀(q). A cluster vector identifier component 202 maps the shortlist embedding x₀(q) 116 to k cluster vectors (c₁, c₂, . . . , cₖ) that are closest to the shortlist embedding x₀(q) 116 in a vector space having m learnable cluster vectors. More specifically, the cluster vector identifier component 202 determines the similarity between the shortlist embedding 116 and each of the m cluster vectors using any similarity metric (e.g., inner product or cosine similarity), and then selects the k cluster vectors that are closest to the shortlist embedding 116. Two vectors that represent semantically similar concepts have a larger inner product than two vectors that represent unrelated concepts. The number of cluster vectors m in the vector space is much less than the number of tokens in the full target vocabulary V.

An offline training process determines r tokens in the target vocabulary V having token parameter vectors that are most semantically related to each cluster vector. In one approach, the offline training process performs this task by computing a Softmax probability score [symbol] _{c}_{ᵢ}(v) between a cluster vector cᵢ and a particular token v using:

$${ℙ}_{{c}_{i}} ( v ) = \frac{exp ( {c}_{i}^{T} {w}_{v} )}{{\sum }_{u ∈ V} exp ( {c}_{i}^{T} {w}_{u} )} . \qquad ( 1 )$$

In this equation

$${c}_{i}^{T} {w}_{v}$$

expresses the inner product between the transpose of the cluster vector cᵢ and a token parameter vector wᵥ associated with the token v. This product describes the semantic similarity between the cluster vector and the token v. Equation (1) normalizes this product by a sum of similarly computed inner products for all of the tokens in the full token target vocabulary V. The offline process then selects the r tokens that have the best probability scores. Each set of r tokens associated with the cluster vector cᵢ is denoted by Wᵢ.

A token cluster identifier component 204 identifies the k clusters of tokens (W₁, W₂, . . . , Wₖ) respectively associated the k cluster vectors (where, to repeat, the association between any cluster of tokens and its cluster vector is precomputed by the offline process). A union component 206 generates the union of these clusters of tokens, which yields the RS vocabulary of tokens W₀(q). That is, W₀(q)=W₁∪W₂ . . . ∪Wₖ.

Different implementations are capable of varying the algorithm described above in FIG. 2 in different ways. For example, in another implementation, the RS vocabulary identifier component 120 computes the shortlist embedding 116 based on the embedding information 114 as a whole, including the response-part embeddings 118. For example, the RS vocabulary identifier component 120 computes the shortlist embedding based on any kind of aggregation of the response-part embeddings (e.g., the average of the response-part embedding or any kind of machine-learned transformation of the response-part embeddings.

FIG. 3 shows an example of the operation of the RS vocabulary identifier component 120 of FIG. 2 for the case of k=3. The cluster vector identifier component 202 maps the shortlist embedding 116 into three cluster vectors (c₁, c₂, c₃). The token cluster identifier component 202 identifies the three clusters of tokens (W₁, W₂, W₃), each of which is associated with a set of r tokens. The union component 206 computes the union of these three clusters of tokens, to generate the RS vocabulary of tokens W₀(q). In general, different implementations can set the hyperparameters m, r, and k to any values. In one example, m=4096, r=20,000, and k=5. The product of r and k (i.e., rk) is much smaller than the total number of candidate tokens in the full target vocabulary V (e.g., 5 million). Hence, the universe of candidate tokens in the RS vocabulary of tokens W₀(q) is much smaller than V.

FIG. 4 shows an example of the operation of the ordered set generator 122, the purpose of which is to generate a group of ranked tokens for each of the response-part embeddings 118. In some implementations, the order set generator 122 computes a probability score [symbol] ₜ(v|q) for each token v in the RS vocabulary of tokens W₀(q), with respect to each response-part embedding xₜ(q), as given by the equation:

$${ℙ}_{t} ( v \vert q ) = \frac{exp ( {{x}_{t} ( q )}^{T} {w}_{v} )}{{\sum }_{u ∈ V} exp ( {{x}_{t} ( q )}^{T} {w}_{u} )} . \qquad ( 2 )$$

In this equation, xₜ(q)^{T}wᵥ expresses the inner product between the transpose of the response-part vector xₜ(q) and a token parameter vector wᵥ associated with the token v. This product describes the semantic similarity between the token embedding vector and the token v. Equation (2) normalizes this product by a sum of similarly computed inner products for all of the tokens in the full target vocabulary V. Alternatively, as will be explained in Section C below, the response-generating system 102 can be trained in such a manner that the inference-stage computation of the denominator of Equation (2) is not necessary. This provision reduces inference-stage computational burden.

Overall, in at least some implementations of the non-autoregressive mode, the ordered set generator 122 produces a group of ranked tokens

$${W}_{0}^{t} ( q )$$

for each of the response-part vectors (at position t) in the set of s response-part vectors. The entries of each group are ranked by their probabilities scores, which expresses their relevance in constructing a corresponding part of the response. That is, a token having a higher probability for a part of the response is more likely to be chosen for use in the response than a token having a lower probability.

FIG. 5 shows an example 502 of the operation of a token selector 126, which performs the role of constructing the parts of the response in steps based on the groups of ranked tokens 124. In some implementations, the token selector 126 performs its function using a constrained beam search algorithm. In this approach, the token selector 126 progresses through the nodes of a trie data structure. Each node in the trie data structure represents a token possibility in a corpus of valid responses (e.g., valid document identifiers). A complete response includes the tokens encountered along a particular path through the trie data structure, from a root node to a leaf node. The token selector 126 assesses the suitability of a current candidate token under consideration (associated with a particular node in the trie data structure) based on its conditional probability, which is a function of its own individual probability score (e.g., computed using Equation 2) and the probability scores of the already-chosen tokens along the path that leads to the current token under consideration. A beam width setting defines the number of possibilities to be considered at each step. In the simplified example of FIG. 5, the beam width is 2.

The selection of available tokens at each step is constrained by the group of ranked tokens associated with this step. For instance, in the example of FIG. 5, at the first step (t=1), assume that the token selector 126 selects a token A and token D from the first group of ranked tokens

$${W}_{0}^{1} ( q )$$

as the two candidate tokens most likely to be used to build the first part of the response. That is, two possibilities are chosen because the beam width is 2. At the second step (t=2), assume that the token selector 126 selects a token E and token F from the group of ranked tokens

$${W}_{0}^{2} ( q )$$

as the two candidate tokens most likely to be used to build the second part of the response. The token E is predicated on the previous selection of token A, and its conditional probability depends on both the probability scores of tokens A and E (e.g., the sum of the logs of these probability scores). Similarly, the token F is predicated on the previous selection of token D, and its conditional probability depends on the probability scores of tokens D and F. The token selector 126 repeats the process of selecting parts of the response until it reaches the last position k. At this time, the token selector 126 chooses the single string of tokens having the highest conditional probability.

Different implementations vary the above token selection strategy in different ways. For example, another implementation penalizes a candidate token for a step t based on the extent to which it is similar to another candidate token that has already been added to a list of candidate tokens for this step. This provision helps ensure diversity among different responses constructed based on the candidate tokens. Alternatively, the token selector 126 considers some tokens that are not found in a relevant group of ranked tokens, but assigns these out-of-group tokens a lower probability score than the tokens in the corresponding group of ranked tokens.

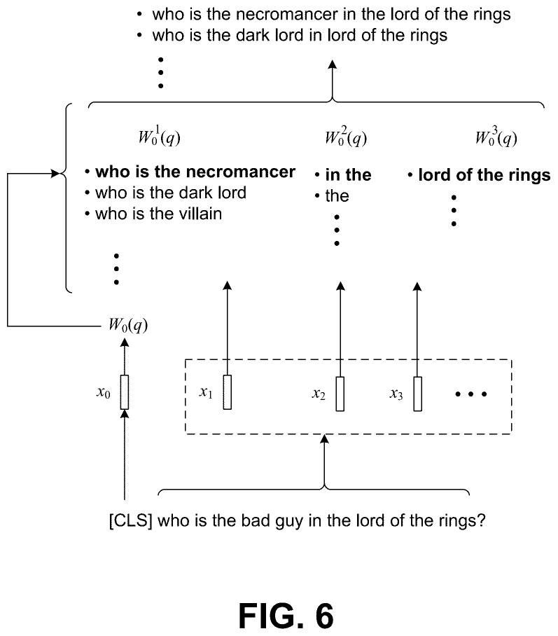

FIG. 6 shows an example of the end-to-end processing of a query in the response-generating system 102 of FIG. 1. The input query q is the question, “who is the bad buy in the lord of the rings?” Assume that the tokenizer 108 consults the input vocabulary to convert the query q into a tokenized query. Further assume that the tokenizer 108 prepends the special “[CLS]” token to the beginning of the tokenized query, in which the CLS token maps to a predetermined code. The encoder 112 maps the CLS token to the shortlist embedding x₀(q) 116. The RS vocabulary identifier component 120 then maps the shortlist embedding 116 to the RS vocabulary of tokens W₀(q) from which the response will be constructed.

The encoder 112 also produces s respective response-part embeddings, including response-part embeddings x₁, x₂, and x₃. In some implementations, the ordered set generator 122 maps these response-part embeddings 118 to respective groups of ranked tokens,

$${W}_{0}^{1} ( q ) , {W}_{0}^{2} ( q ) , {W}_{0}^{3} ( q ) .$$

Each of the groups of ranked tokens 124 includes tokens drawn from the RS vocabulary of tokens that have been determined to be relevant in constructing a part of the response. For example, the first group of ranked tokens includes an ordered set of candidate tokens with “who is the necromancer” being the most likely, “who is the dark lord” being the next most likely, “who is the villain” being the next most likely, and so on.

The token selector 126 constructs one or more candidate responses by drawing from the groups of ranked tokens 124. For example, the token selector 126 identifies the response “who is the necromancer in the lord of the rings” as the most likely, and “who is the dark lord in lord of the rings” as the next most likely, and so on. In one application, each of these responses is a candidate document identifier. A retrieval component accesses a document associated with each document identifier, and generates output information based on the document. Alternatively, the document identifiers are the final results of analysis performed by the response-generating system 102.

The response-generating system 102 is technically advantageous because it is capable of reducing the number of computations that are performed in generating a response. The response-generating system 102 achieves this effect by restricting the number of candidate tokens that are considered by the token selector 126. That is, the token selector 126 need not consider the entire universe of available tokens in the target vocabulary V, but only those tokens that have been determined to be most relevant in interpreting the response-part embeddings 118. This has two consequences. First, the response-generating system 102 is able to reduce the amount of processing and memory resources that it uses to generate the response. This characteristic expands the range of devices that are capable of implementing the response-generating system 102. For instance, some user devices are capable of individually implementing the response-generating system 102. Second, the response-generating system 102 is able to reduce the latency at which it provides the response. This characteristic allows the response-generating system 102 to be used in online applications that demand low-latency responses, such as search applications and ad-serving applications.

The response-generating system 102 of FIG. 1 is capable of being implemented by at least a non-autoregressive generative model and an autoregressive generative model. “Autoregressive” means that, for a beam width of 1, the response-generating system 102 generates the tokens of the response over plural passes, one token at a time. At the end of each pass, the response-generating system 102 adds a new token that has been predicted to the end of the response being constructed, to produce an updated response. In the next pass, the response-generating system 102 analyzes the updated response to generate the next token. This iterative process continues until the response-generating system 102 predicts a special end-of-sequence token. In contrast, a non-autoregressive model maps all of the response-part embeddings 118 to the full response in a single pass, that is, in parallel. The non-autoregressive mode of operation has lower latency compared to the autoregressive mode because it eliminates the iterative prediction of tokens performed in the autoregressive mode, which involves plural passes through the layers of a transformer language model.

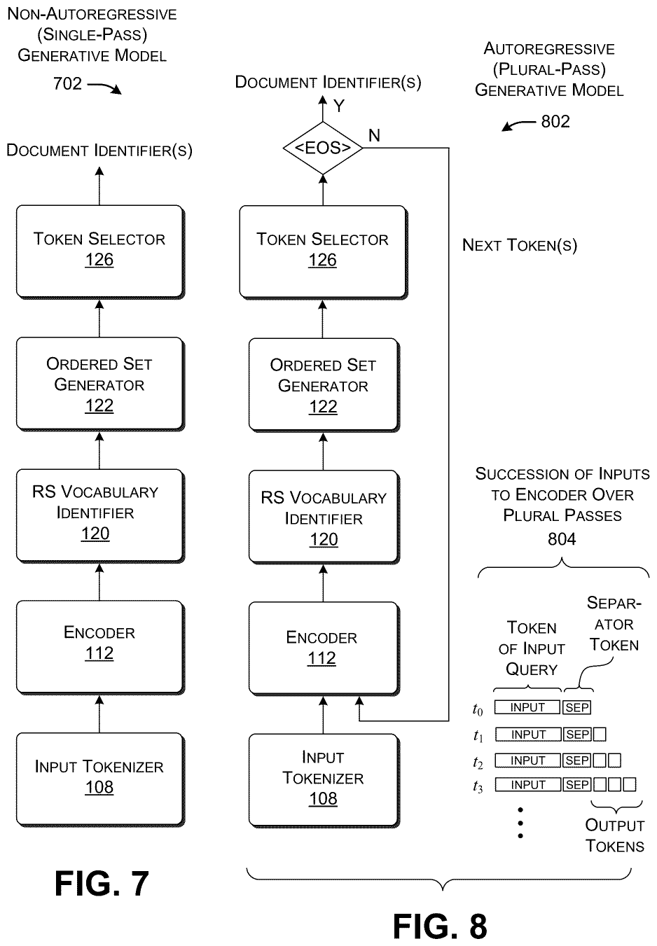

FIG. 7 summarizes a non-autoregressive generative model 702. The input tokenizer 108, encoder 112, RS vocabulary identifier component 120, and ordered set generator 122 operate in the same manner described above. The token selector 126 constructs the response in a single pass based on the groups of ranked tokens 124 provided by the ordered set generator 122.

FIG. 8 summarizes an autoregressive generative model 802. This model 802 is capable of generating tokens over plural passes in different ways. The general goal of each pass is to generate at least one next token based on whatever input tokens have been received and produced so far. For example, consider the simplified case in which the beam width is set to 1. In a first pass, the tokenizer 108, encoder 112, and RS vocabulary identifier component 120 operate in the same manner described above to generate a RS vocabulary of tokens W₀(q). The ordered set generator 122 ranks the RS vocabulary of tokens, to produce a group of ordered tokens to be applied in predicting the next token. The ordered set generator 122 performs its ranking based on any embedding information produced by the encoder 112, such as a particular response-part embedding associated with the token position of interest, or some aggregation of plural response-part embeddings. The token selector 126 uses the beam search algorithm to select the first token of the response, as constrained by the group of ordered tokens produced by the ordered set generator 122. The autoregressive generative model 802 then adds the predicted first token to the end of the sequence of input tokens previously input to the encoder 112, to produce an updated sequence of input tokens.

In a second pass, the autoregressive generative model 802 repeats the above-described processing on the updated sequence of input tokens to produce a second token in the response. In some implementations, the RS vocabulary of tokens is considered static across all tokens of the response, and therefore it is not necessary to update the RS vocabulary of tokens. Alternatively, the RS vocabulary identifier component 120 produces an updated RS vocabulary of tokens based on the updated embedding information produced by the encoder 112 in response to the updated sequence of input tokens. In either case, the ordered set generator 122 ranks the RS vocabulary of tokens based on an appropriate part of the updated embedding information produced by the encoder 112. The above process continues until the token selector 126 generates an end-of-sequence token. Reference number 804 summarizes an illustrative sequence of inputs fed to the encoder 112 over plural passes, with a SEP token separating the initial query and the tokens of the response that is built over plural passes.

Examples in which the beam width is greater than 1 follow the same flow described above, with the exception that the autoregressive generative model 802 will explore each candidate token at each pass. For instance, assume that the first pass produces two candidate next tokens because the beam width is set to 2. The autoregressive generative model 802 will perform the same operations described above for each of the two candidate next tokens.

### B. Vocabulary-Building Component

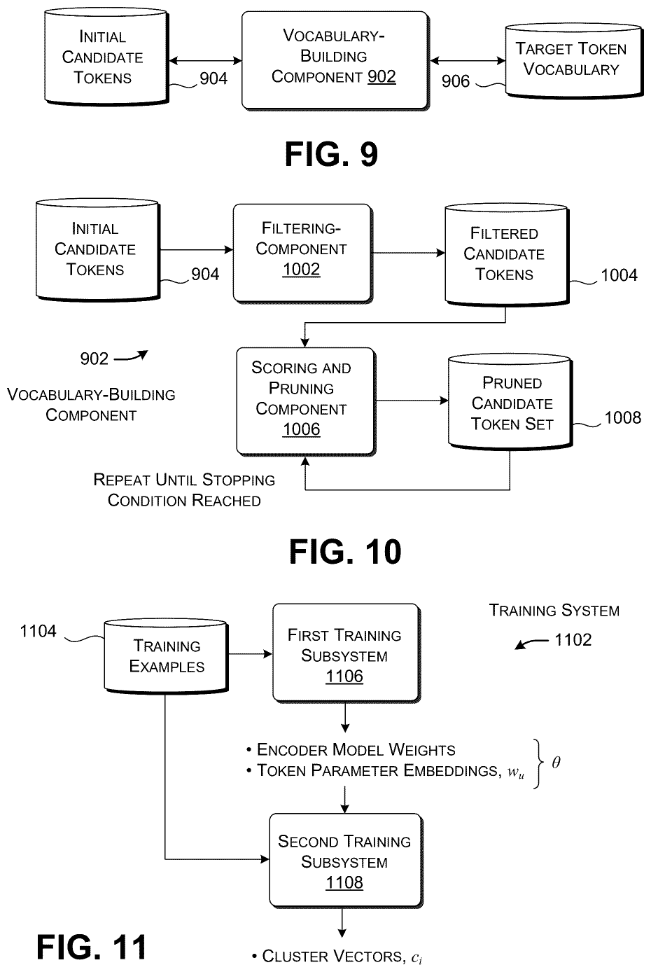

FIG. 9 shows a vocabulary-building component 902 that builds a target vocabulary of tokens for use by the response-generating system 102 of FIG. 1. The vocabulary-building component 902 operates on a data set in a data store 904 that contains all potential character substrings found in a specified corpus of documents, up to a specified maximum length. The vocabulary-building component 902 selects a subset of these candidate tokens for inclusion in the full target vocabulary V that will be used by the response-generating system 102. A data store 906 stores the full target vocabulary V.

FIG. 10 shows one implementation of the vocabulary-building component 902 of FIG. 9. In a first stage, a filtering component 1002 filters the initial candidate tokens in the data store 904 based on a set of rules. For instance, the filtering component 1002 eliminates candidate tokens that do not begin and end at full-word boundaries. The filtering component 1002 also eliminates candidates that have characters with inconsistencies in character types (e.g., by combining any two or more of letters, numbers, and/or punctuation). The filtering component 1002 also eliminates candidates that do not appear a prescribed number of times in the corpus of documents. A data store 1004 stores the final set of filtered candidate tokens.

In a second stage, a scoring and pruning component 1006 tokenizes a corpus of text with a randomly selected set of candidate tokens having a prescribed initial size. The scoring and pruning component 1006 then measures the efficiency of each token based on the total number of characters it compresses in the document corpus. The scoring and pruning component 1006 removes candidate tokens that have the worst efficiency scores, resulting in a reduced set of candidate tokens provided in a data store 1008. This process is repeated until the set of candidate tokens reaches a target prescribed size. Overall, the process of FIG. 10 is the opposite of the commonly-used byte pair encoding (BPE), which grows tokens by successive string-merging operations. That is, the process of FIG. 10 is opposite to BPE because it successively removes tokens from a larger collection of candidate tokens.

Other implementations of the vocabulary-building component 902 include one or more variations to the process of FIG. 10. For instance, one variation re-injects previously rejected tokens into the set of chosen candidate tokens. The process then re-evaluates the efficiency of each token. This does not result in redundant calculations because a candidate token may score differently when considered in combination with a new group of candidate tokens, which provides a new context.

The final target vocabulary V will contain plural-word tokens, each of which includes two or more words. These plural-word tokens are useful because they express relationships among words that are not expressed by single-word tokens. The non-autoregressive generative model 702 of FIG. 7 especially benefits from the inclusion of plural-word tokens because it does not analyze dependency among words in the same manner as the autoregressive generative model 802 of FIG. 8, and therefore may not learn these inter-word relationships in the same manner as the autoregressive generative model 802. This might lead the non-autoregressive generative model 702 to propose responses that incorrectly combine tokens into a single response that should correctly be parts of separate competing responses.

The inclusion of plural-word tokens increases the total number of tokens in the target vocabulary V. The provisions described in Section A prevent this increased number of tokens from unduly slowing the operation of the token selector 126. This is because, as explained above, the token selector 126 is constrained by the groups of ranked tokens 124 generated by the ordered set generator 122, and need not consider the complete universe of tokens in the full target vocabulary V.

The use of plural-word tokens also has the effect of reducing the number of tokens in each response on average. This is because one or more tokens in a response include plural-word tokens. This characteristic allows the response-generating system 102 to produce a response with fewer token predictions, which, in turn, is capable of decreasing the use of resources by the response-generating system 102 and decreasing its latency. Note, however, that decreasing the number of tokens in any response does not necessarily decrease its length as measured in the number of words in the response. This is because, although there are fewer tokens, they may be individually larger on average than single-word or partial-word tokens.

### C. Training System

FIG. 11 shows a training system 1102 for training parts of the response-generating system 102 of FIG. 1. The training system 1102 operates on a set of training examples that include pairs of queries and document identifiers, e.g., (q₁,d₁), . . . (q_{N},d_{N}). A data store 1104 stores the training examples. The training system 1102 trains the response-generating system 102 in two stages. That is, a first training subsystem 1106 trains the weights of the encoder 112 and the token parameter vectors wᵤ. These weights and parameter vectors are collectively denoted as 0. In some examples, the encoder 112 is a language model having pretrained weights, and the first training subsystem 1106 refines these weights (rather than training the weight from scratch). A second training subsystem 1108 trains the cluster vectors (c₁, c₂, . . . , cₘ).

In some implementations, the first training subsystem 1106 minimizes a loss function L(θ) that includes plural component loss terms (e.g., L₁(θ), L₂(θ), L₃(θ)). The first loss term L₁(θ) expresses the difference between the model-predicted document identifiers and actual ground-truth document identifiers specified in the training examples. In some implementations, the first training subsystem 1106 expresses this loss term using cross entropy:

$${L}_{1} ( θ ) = - {\sum }_{i = 1}^{N} {\sum }_{t = 1}^{s} log [ {ℙ}_{t} ( {d}_{i}^{t} \vert {q}_{i} ) ] . \qquad ( 3 )$$

The outer summation in this equation represents the consideration of N queries, each denoted by qᵢ. The inner summation represents the consideration of the s response-part embeddings 118, each denoted by xₜ. The inner term

$${ℙ}_{t} ( {d}_{i}^{t} \vert {q}_{i} )$$

expresses the probability that a predicted document identifier agrees with the associated ground-truth document identifier, given a particular query.

The second loss term L₁(θ) measures the extent to which the RS vocabulary of tokens W₀(q) supplies the tokens that are used to construct all parts of the ground-truth document identifiers. The first training subsystem 1106 expresses this loss term using cross entropy.

$${L}_{2} ( θ ) = - {\sum }_{i = 1}^{N} {\sum }_{t = 1}^{s} log [ {ℙ}_{0} ( {d}_{i}^{t} \vert {q}_{i} ) ] . \qquad ( 4 )$$

The third loss term L₃(θ) is a self-normalization term that allows efficient computation of the Softmax-based probability scores in the inference stage using Equation (2). In some implementations, the third loss term is given by:

$${L}_{3} ( θ ) = - {\sum }_{i = 1}^{N} {\sum }_{t = 1}^{s} {log}^{2} [ {\sum }_{v ∈ V} exp ( {{x}_{t} ( {q}_{i} )}^{T} {w}_{v} ) ] . \qquad ( 5 )$$

This loss term expresses the logarithm of the square of a sum of exponentials. Each inner product measures the similarity between a particular response-part embedding xₜ at position t and a particular token parameter vector wᵥ associated with a token v. By including this loss term in the training stage, the calculation of the probability score [symbol] ₜ(v|q) in the inference stage of Equation (2) can be replaced with its more efficient counterpart [symbol] ₜ(v,q)=exp(xₜ(qᵢ)^{T}wᵥ). More specifically, this variation is more efficient because it eliminates the computation-intensive operation in the denominator of Equation (2) which requires evaluating inner products over the entire token target vocabulary V in the inference stage.

The overall loss term L(θ) is expressed as the weighted combination of the above three loss terms as follows:

$$L ( θ ) = {L}_{1} ( θ ) + {λ}_{2} {L}_{2} ( θ ) + {λ}_{3} {L}_{3} ( θ ) . \qquad ( 6 )$$

The symbols λ₂ and λ₃ represent hyper-parameters to be tuned. In one example, λ₂ and λ₃ are set to 0.25 and 1.0 respectively.

For the second training subsystem 1108, for each training pair (q₁,d₁), i∈N, let eᵢ∈[m] be such that the cluster vector cₑ_{ᵢ} has the largest inner product with the shortlist embedding x₀(qᵢ) qᵢ. This relationship is mathematically expressed as:

$${e}_{i} = {arg max}_{j ∈ [ m ]} < {x}_{0} ( {q}_{i} ) , {c}_{j} > . \qquad ( 7 )$$

The second training subsystem 1108 iteratively maximizes the likelihood that the cluster vector cₑ_{ᵢ} which is most aligned with the shortlist embedding x₀(qᵢ) 116, will lead to the generation of the tokens in the correct document identifier. This will also ensure that the cluster of tokens We, will have a high likelihood of containing the tokens in dᵢ. Further, the implementation described above with reference to FIGS. 1 and 2 finds the k cluster vectors that have the highest inner product with the shortlist embedding x₀(qᵢ) 116, not a single most aligned vector cₑ_{ᵢ}. This enhances the chances that the tokens in dᵢ will be present in the RS vocabulary tokens W₀(q), since W₀(q) represents the union of the clusters of tokens associated with these k cluster vectors.

Mathematically, the training objective of the second training subsystem 1108 represents the minimization of a function L (c₁, c₂, . . . , cₘ) that expresses the cross entropy loss between the Softmax distributions [symbol] and the document identifiers dᵢ:

$$L ( {c}_{1} , {c}_{2} , … , {c}_{m} ) = - {\sum }_{i = 1}^{N} {\sum }_{t = 1}^{s} log [ {ℙ}_{{c}_{{e}_{i}}} ( {d}_{i}^{t} ) ] . \qquad ( 8 )$$

### D. Illustrative Language Model

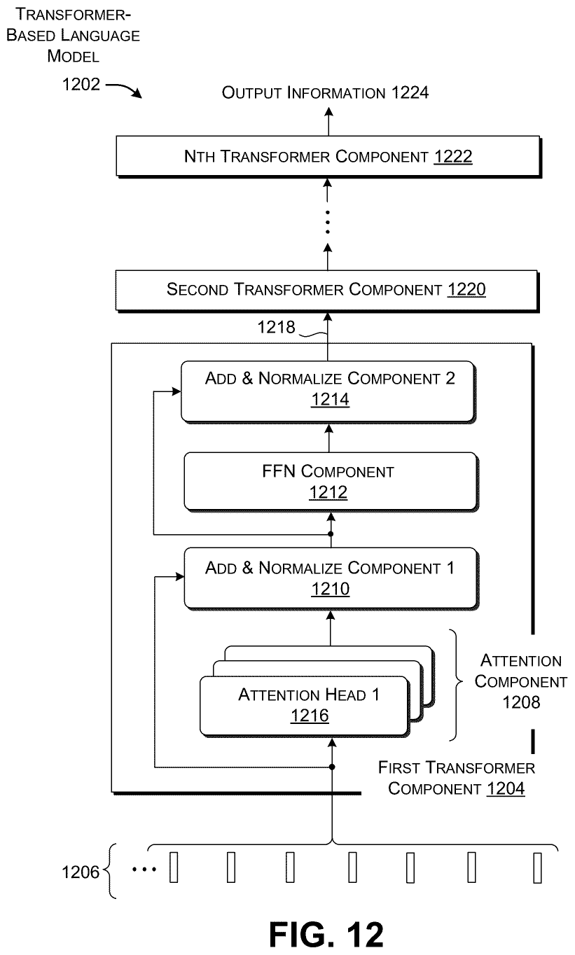

FIG. 12 shows a transformer-based language model (“language model”) 1202 for implementing the encoders 112 of the generative models (702, 802). The language model 1202 is composed, in part, of a pipeline of transformer components, including a first transformer component 1204. FIG. 12 provides details regarding one way to implement the first transformer component 1204. Although not specifically illustrated, other transformer components of the language model 1202 have the same architecture and perform the same functions as the first transformer component 1204 (but are governed by separate sets of weights).

The language model 1202 receives the tokenized query. In the autoregressive variant, the tokenized input may also include a tokenized version of a response that is being constructed in its current state. An embedding component (not shown) maps the sequence of tokens into respective token vectors. For example, the embedding component produces one-hot vectors that describe the tokens, and then maps the one-hot vectors into the token vectors using a machine-trained linear transformation. The embedding component then adds position information (and, in some cases, segment information) to the respective token vectors to produce position-supplemented embedding vectors 1206. The position information added to each token vector describes the embedding vector's position in the sequence of token embeddings.

The first transformer component 1204 operates on the position-supplemented embedding vectors 1206. In some implementations, the first transformer component 1204 includes, in order, an attention component 1208, a first add-and-normalize component 1210, a feed-forward neural network (FFN) component 1212, and a second add-and-normalize component 1214.

The attention component 1208 determines how much emphasis should be placed on parts of input information when interpreting other parts of the input information. Consider, for example, a sentence that reads: “I asked the professor a question, but he could not answer it.” When interpreting the word “it,” the attention component 1208 will determine how much weight or emphasis should be placed on each of the words of the sentence. The attention component 1208 will find that the word “question” is most significant.

The attention component 1208 performs attention analysis using the following equation:

$$Attention ( Q , K , V ) = softmax ( \frac{Q {K}^{T}}{\sqrt{{d}_{k}}} ) V . \qquad ( 9 )$$

The attention component 1208 produces query information Q by multiplying the position-supplemented embedding vectors 1206 by a query weighting matrix W^{Q}. Similarly, the attention component 1208 produces key information K and value information V by multiplying the position-supplemented embedding vectors 1206 by a key weighting matrix W^{K} and a value weighting matrix W^{V}, respectively. To execute Equation (9), the attention component 1208 takes the dot product of Q with the transpose of K, and then divides the dot product by a scaling factor \sqrt{d}, to produce a scaled result. The symbol d represents the dimensionality of Q and K. The attention component 1208 takes the Softmax (normalized exponential function) of the scaled result, and then multiplies the result of the Softmax operation by V, to produce attention output information. In some cases, the attention component 1208 is said to perform masked attention insofar as the attention component 1208 masks output token information that, at any given time, has not yet been determined. Background information regarding the general concept of attention is provided in Vaswani, et al., “Attention Is All You Need,” in 31st Conference on Neural Information Processing Systems (NIPS 2017), 2017, 11 pages.

Note that FIG. 12 shows that the attention component 1208 is composed of plural attention heads, including a representative attention head 1216. Each attention head performs the computations specified by Equation (9), but with respect to a particular representational subspace that is different than the subspaces of the other attention heads. To accomplish this operation, the attention heads perform the computations described above using different respective sets of query, key, and value weight matrices. Although not shown, the attention component 1208 concatenates the output results of the attention component's separate attention heads, and then multiplies the results of this concatenation by another weight matrix W^{O}.

The add-and-normalize component 1210 includes a residual connection that combines (e.g., sums) input information fed to the attention component 1208 with the output information generated by the attention component 1208. The add-and-normalize component 1210 then normalizes the output information generated by the residual connection, e.g., by layer-normalizing values in the output information based on the mean and standard deviation of those values, or by performing root-mean-squared normalization. The other add-and-normalize component 1214 performs the same functions as the first-mentioned add-and-normalize component 1210. The FFN component 1212 transforms input information to output information using a feed-forward neural network having any number of layers.

The first transformer component 1204 produces output information 1218. A series of other transformer components (1220, . . . , 1222) perform the same functions as the first transformer component 1204, each operating on output information produced by its immediately preceding transformer component. Each transformer component uses its own level-specific set of machine-trained weights. The final transformer component 1222 in the language model 1202 produces final output information 1224.

Other implementations of the language model 1202 use other kinds of machine-trained models besides, or in addition to, the particular transformer-based architecture shown in FIG. 12. The other machine-trained models include any of convolutional neural networks (CNNs), recurrent neural networks (RNNs), state space models (SSMs) (including Mamba models), fully-connected feed-forward neural networks (FFNS), stable diffusion models, etc., or any combination thereof.

### E. Illustrative Processes

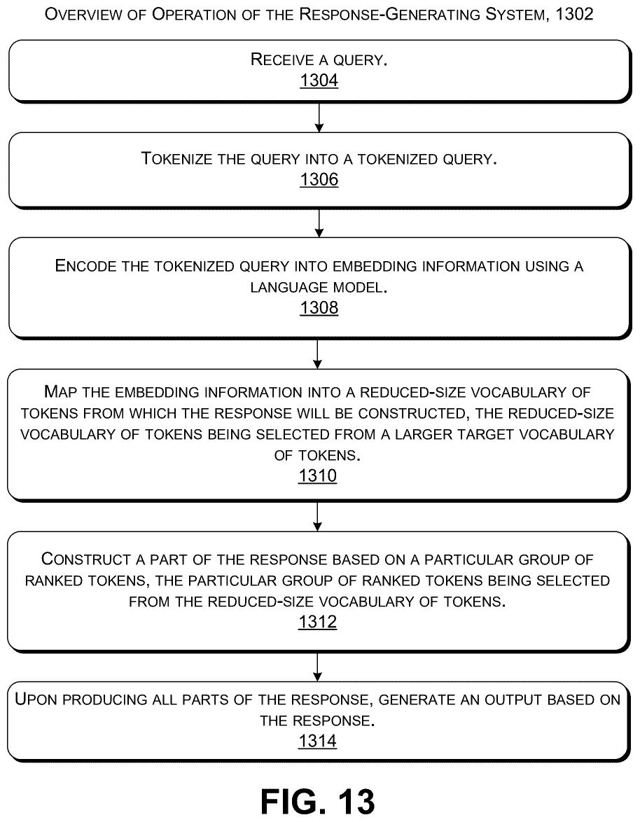

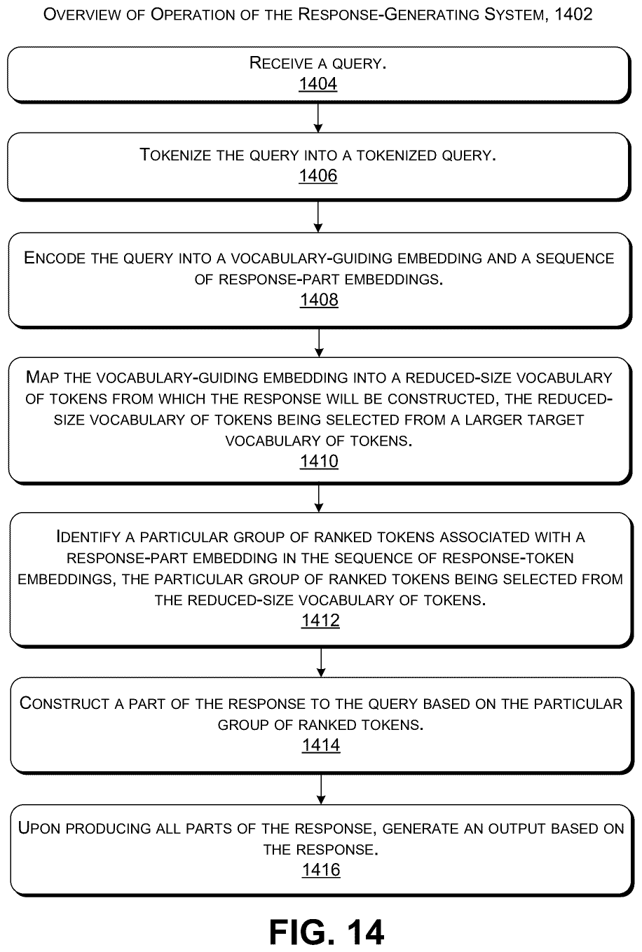

FIGS. 13 and 14 show two processes that represent an overview of the operation of the response-generating system 102 of FIG. 1. Each of the processes is expressed as a series of operations performed in a particular order. But the order of these operations is merely representative, and the operations are capable of being varied in other implementations. Further, any two or more operations described below are capable of being performed in a parallel manner. In one implementation, the blocks shown in the processes that pertain to processing-related functions are implemented by the computing equipment described in connection with FIGS. 15 and 16.

More specifically, FIG. 13 shows an overview of a process 1302 for generating a response using a generative model. In block 1304, the response-generating system 102 receives a query. In block 1306, the response-generating system tokenizes the query into a tokenized query. In block 1308, the response-generating system 102 encodes the tokenized query into embedding information using a language model (e.g., the language model 1202 of FIG. 12). In block 1310, the response-generating system 102 maps the embedding information into a reduced-size vocabulary of tokens from which the response will be constructed, the reduced-size vocabulary of tokens being selected from a larger target vocabulary of tokens. In block 1312, the response-generating system 102 constructs a part of the response based on a particular group of ranked tokens, the particular group of ranked tokens being selected from the reduced-size vocabulary of tokens. In block 1314, upon producing all parts of the response, the response-generating system 102 generates an output based on the response.

FIG. 14 shows an overview of another process 1402 for generating a response using a generative model that represents one implementation of the process 1302 of FIG. 13. In block 1404, the response-generating system 102 receives a query. In block 1406, the response-generating system 102 tokenizes the query into a tokenized query. In block 1408, the response-generating system 102 encodes the tokenized query into a vocabulary-guiding embedding and a sequence of response-part embeddings. In block 1410, the response-generating system 102 maps the vocabulary-guiding embedding into a reduced-size vocabulary of tokens from which the response will be constructed, the reduced-size vocabulary of tokens being selected from a larger target vocabulary of tokens. In block 1412, the response-generating system 102 identifies a particular group of ranked tokens associated with a particular response-part embedding in the sequence of response-part embeddings, the particular group of ranked tokens being selected from the reduced-size vocabulary of tokens. In block 1414, the response-generating system 102 constructs a part of the response to the query based on the particular group of ranked tokens. In block 1416, upon producing all parts of the response, the response-generating system 102 generates an output based on the response.

The response-generating system 102 produces accurate retrieval results, e.g., measured by the extent to which it produces document identifiers that that are relevant to the query. The accuracy of the response-generating system 102 is attributed, in part, to its incorporation of plural-word tokens, combined with the vocabulary constraints it places on the token selector 126.

### F. Illustrative Computing Systems

FIG. 15 shows computing equipment 1502 that, in some implementations, is used to implement the response-generating system 102. The computing equipment 1502 includes a set of local devices 1504 coupled to a set of servers 1506 via a computer network 1508. Each local device corresponds to any type of computing device, including any of a desktop computing device, a laptop computing device, a handheld computing device of any type (e.g., a smartphone or a tablet-type computing device), a mixed reality device, an intelligent appliance, a wearable computing device (e.g., a smart watch), an Internet-of-Things (IoT) device, a gaming system, an immersive “cave,” a media device, a vehicle-borne computing system, any type of robot computing system, a computing system in a manufacturing system, etc. In some implementations, the computer network 1508 is implemented as a local area network, a wide area network (e.g., the Internet), one or more point-to-point links, or any combination thereof.

The bottom-most overlapping box in FIG. 15 indicates that the functionality of the response-generating system 102 is capable of being spread across the local devices 1504 and/or the servers 1506 in any manner. In one example, the response-generating system 102 is entirely implemented by a local device. In another example, the functions of the response-generating system 102 are entirely implemented by the servers 1506. Here, a user is able to interact with the servers 1506 via a browser application running on a local device. In other examples, some of the functions of the response-generating system 102 are implemented by a local device, and other functions of the response-generating system 102 are implemented by the servers 1506.

Although not shown in FIG. 15, the functionality of vocabulary-building component 902 (of FIG. 9) and the training system 1102 (of FIG. 11) can be similarly distributed between the local devices 1504 and the servers 1506 in any described above.

FIG. 16 shows a computing system 1602 that, in some implementations, is used to implement any aspect of the mechanisms set forth in the above-described figures. For instance, in some implementations, the type of computing system 1602 shown in FIG. 16 is used to implement any local computing device or any server shown in FIG. 15. In all cases, the computing system 1602 represents a physical and tangible processing mechanism.

The computing system 1602 includes a processing system 1604 including one or more processors. The processor(s) include one or more central processing units (CPUs), and/or one or more graphics processing units (GPUs), and/or one or more application specific integrated circuits (ASICs), and/or one or more neural processing units (NPUs), and/or one or more tensor processing units (TPUs), etc. More generally, any processor corresponds to a general-purpose processing unit or an application-specific processor unit.

The computing system 1602 also includes computer-readable storage media 1606, corresponding to one or more computer-readable media hardware units. The computer-readable storage media 1606 retains any kind of information 1608, such as machine-readable instructions, settings, model weights, and/or other data. In some implementations, the computer-readable storage media 1606 includes one or more solid-state devices, one or more hard disks, one or more optical disks, etc. Any instance of the computer-readable storage media 1606 represents a fixed or removable unit of the computing system 1602. Further, any instance of the computer-readable storage media 1606 provides volatile and/or non-volatile retention of information. The specific term “computer-readable storage medium” or “storage device” expressly excludes propagated signals per se in transit; a computer-readable storage medium or storage device is “non-transitory” in this regard.

The computing system 1602 utilizes any instance of the computer-readable storage media 1606 in different ways. For example, in some implementations, any instance of the computer-readable storage media 1606 represents a hardware memory unit (such as random access memory (RAM)) for storing information during execution of a program by the computing system 1602, and/or a hardware storage unit (such as a hard disk) for retaining/archiving information on a more permanent basis. In the latter case, the computing system 1602 also includes one or more drive mechanisms 1610 (such as a hard drive mechanism) for storing and retrieving information from an instance of the computer-readable storage media 1606.

In some implementations, the computing system 1602 performs any of the functions described above when the processing system 1604 executes computer-readable instructions stored in any instance of the computer-readable storage media 1606. For instance, in some implementations, the computing system 1602 carries out computer-readable instructions to perform each block of the processes described with reference to FIGS. 13 and 14. FIG. 16 generally indicates that hardware logic circuitry 1612 includes any combination of the processing system 1604 and the computer-readable storage media 1606.

In addition, or alternatively, the processing system 1604 includes one or more other configurable logic units that perform operations using a collection of logic gates, such as field-programmable gate arrays (FPGAs), etc. In these implementations, the processing system 1604 effectively incorporates a storage device that stores computer-readable instructions, insofar as the configurable logic units are configured to execute the instructions and therefore embody or store these instructions.

In some cases (e.g., in the case in which the computing system 1602 represents a user computing device), the computing system 1602 also includes an input/output interface 1614 for receiving various inputs (via input devices 1616), and for providing various outputs (via output devices 1618). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1620 and an associated graphical user interface presentation (GUI) 1622. The display device 1620 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1602 also includes one or more network interfaces 1624 for exchanging data with other devices via one or more communication conduits 1626. One or more communication buses 1628 communicatively couple the above-described units together.

The communication conduit(s) 1626 is implemented in any manner, e.g., by a local area computer network, a wide area computer network (e.g., the Internet), point-to-point connections, or any combination thereof. The communication conduit(s) 1626 include any combination of hardwired links, wireless links, routers, gateway functionality, name servers, etc., governed by any protocol or combination of protocols.

FIG. 16 shows the computing system 1602 as being composed of a discrete collection of separate units. In some cases, the collection of units corresponds to discrete hardware units provided in a computing device chassis having any form factor. FIG. 16 shows illustrative form factors in its bottom portion. In other cases, the computing system 1602 includes a hardware logic unit that integrates the functions of two or more of the units shown in FIG. 16. For instance, in some implementations, the computing system 1602 includes a system on a chip (SoC or SOC), corresponding to an integrated circuit that combines the functions of two or more of the units shown in FIG. 16.

The following summary provides a set of illustrative examples of the technology set forth herein.
(A1) According to one aspect, a method (e.g., the process 1402) is described for generating a response using a generative model. In block 1404, the response-generating system 102 receives a query. In block 1406, the response-generating system 102 tokenizes the query into a tokenized query. In block 1408, the response-generating system 102 encodes the tokenized query into a vocabulary-guiding embedding and a sequence of response-part embeddings. In block 1410, the response-generating system 102 maps the vocabulary-guiding embedding into a reduced-size vocabulary of tokens, the reduced-size vocabulary of tokens being selected from a larger target vocabulary of tokens from which the response will be constructed. In block 1412, the response-generating system 102 identifies a particular group of ranked tokens associated with a particular response-part embedding in the sequence of response-part embeddings, the particular group of ranked tokens being selected from the reduced-size vocabulary of tokens. In block 1414, the response-generating system 102 constructs a part of the response to the query based on the particular group of ranked tokens. In block 1416, the response-generating system 102, upon producing all parts of the response, generates an output based on the response.
(A2) According to some implementations of the method of A1, the larger target vocabulary of tokens includes at least some plural-word tokens, each of the plural-word tokens including a sequence of two or more words.
(A3) According to some implementations of the methods of A1 or A2, the mapping includes: identifying a set of cluster vectors that are closest to the vocabulary-guiding embedding in a vector space; identifying clusters of token parameter vectors that are closest to the respective cluster vectors in the vector space, the clusters of token parameter vectors being associated with respective clusters of tokens; and identifying the reduced-size vocabulary of tokens by forming a union of the clusters of tokens.
(A4) According to some implementations of any of the methods of A1-A3, the particular group of ranked tokens associated with the particular response-part embedding is identified by finding tokens in the reduced-size vocabulary of tokens having token parameter vectors that are closest to the particular response-part embedding in a vector space.
(A5) According to some implementations of any of the methods of A1-A4, the constructing is performed using a beam search process, in which selection of the part of the response is constrained by the particular group of ranked tokens associated with the particular response-part embedding.
(A6) According to some implementations of any of the methods of A1-A5, the encoding is performed using a language model.
(A7) According to some implementations of the method of A5, the language model is a transformer language model.
(A8) According to some implementations of any of the methods of A1-A7, the identifying a particular group of ranked tokens includes identifying plural groups of ranked tokens, the plural groups of ranked tokens being selected from the reduced-size vocabulary of tokens based on the respective response-part embeddings. The parts of the response are generated non-autoregressively in a single pass based on the plural groups of ranked tokens.
(A9) According to some implementations of any of the methods of A1-A7, the parts of the response are generated autoregressively in plural passes.
(A10) According to some implementations of any of the methods of A1-A9, the response expresses one or more document identifiers. The method further includes using the one or more document identifiers to access one or more documents that are associated with the one or more document identifiers. The output that is generated includes information regarding the one or more documents.
(B1) According to one aspect, a method (e.g., the process 1302) is described for generating a response using a generative model, In block 1304, the response-generating system 102 receives a query. In block 1306, the response-generating system 102 tokenizes the query into a tokenized query. In block 1308, the response-generating system 102 encodes the tokenized query into embedding information using a language model. In block 1310, the response-generating system 102 maps the embedding information into a reduced-size vocabulary of tokens from which the response will be constructed, the reduced-size vocabulary of tokens being selected from a larger target vocabulary of tokens. In block 1312, the response-generating system 102 constructs a part of the response based on a particular group of ranked tokens, the particular group of ranked tokens being selected from the reduced-size vocabulary of tokens. In block 1314, the response-generating system, upon producing all parts of the response, generates an output based on the response.

In yet another aspect, some implementations of the technology described herein include a computing system (e.g., the computing system 1602) that includes a processing system (e.g., the processing system 1604) having a processor. The computing system also includes a storage device (e.g., the computer-readable storage media 1606) for storing computer-readable instructions (e.g., the information 1608). The processing system executes the computer-readable instructions to perform any of the methods described herein (e.g., any individual method of the methods of A1-A10 and B1).

In yet another aspect, some implementations of the technology described herein include a computer-readable storage medium (e.g., the computer-readable storage media 1606) for storing computer-readable instructions (e.g., the information 1608). A processing system (e.g., the processing system 1604) executes the computer-readable instructions to perform any of the operations described herein (e.g., the operations in any individual method of the methods of A1-A10 and B1).

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

This description may have identified one or more features as optional. This type of statement is not to be interpreted as an exhaustive indication of features that are to be considered optional; generally, any feature is to be considered as an example, although not explicitly identified in the text, unless otherwise noted. Further, any features described as alternative ways of carrying out identified functions or implementing identified mechanisms are also combinable together in any combination, unless otherwise noted.

In terms of specific terminology, the phrase “configured to” encompasses various physical and tangible mechanisms for performing an identified operation. The mechanisms are configurable to perform an operation using the hardware logic circuitry 1612 of FIG. 16. The term “logic” likewise encompasses various physical and tangible mechanisms for performing a task. For instance, each processing-related operation illustrated in the flowcharts of FIGS. 13 and 14 corresponds to a logic component for performing that operation.

Further, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” is a group that includes one or more members. The phrase “A corresponds to B” means “A is B” in some contexts. The term “prescribed” is used to designate that something is purposely chosen according to any environment-specific considerations. For instance, a threshold value or state is said to be prescribed insofar as it is purposely chosen to achieve a desired result. “Environment-specific” means that a state is chosen for use in a particular environment. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for generating a response using a generative model, comprising:
receiving a query;
encoding the query into a vocabulary-guiding embedding and a sequence of response-part embeddings;
mapping the vocabulary-guiding embedding into a reduced-size vocabulary of tokens from which the response will be constructed, the reduced-size vocabulary of tokens being selected from a larger target vocabulary of tokens;
identifying a particular group of ranked tokens associated with a response-part embedding in the sequence of response-token embeddings, the particular group of ranked tokens being selected from the reduced-size vocabulary of tokens;
constructing a part of the response to the query based on the particular group of ranked tokens; and
upon producing all parts of the response, generating an output based on the response.

2. The method of claim 1, wherein the larger target vocabulary of tokens includes at least some plural-word tokens, each of the plural-word tokens including a sequence of two or more words.

3. The method of claim 1, wherein the mapping comprises:
identifying a set of cluster vectors that are closest to the vocabulary-guiding embedding in a vector space;
identifying clusters of token parameter vectors that are closest to the respective cluster vectors in the vector space, the clusters of token parameter vectors being associated with respective clusters of tokens; and
identifying the reduced-size vocabulary of tokens by forming a union of the clusters of tokens.

4. The method of claim 1, wherein the particular group of ranked tokens associated with the particular response-part embedding is identified by finding tokens in the reduced-size vocabulary of tokens having token parameter vectors that are closest to the particular response-part embedding in a vector space.

5. The method of claim 1, wherein the constructing is performed using a beam search process, in which selection of the part of the response is constrained by the particular group of ranked tokens associated with the particular response-part embedding.

6. The method of claim 1, wherein the encoding is performed using a language model.

7. The method of claim 6, wherein the language model is a transformer language model.

8. The method of claim 1,
wherein the identifying a particular group of ranked tokens includes identifying plural groups of ranked tokens, the plural groups of ranked tokens being selected from the reduced-size vocabulary of tokens based on the respective response-part embeddings, and
wherein the parts of the response are generated non-autoregressively in a single pass based on the plural groups of ranked tokens.

9. The method of claim 1, wherein the parts of the response are generated autoregressively in plural passes.

10. The method of claim 1,
wherein the response expresses one or more document identifiers,
wherein the method further comprises using the one or more document identifiers to access one or more documents that are associated with the one or more document identifiers, and
wherein the output that is generated includes information regarding the one or more documents.

11. A computing system for generating a response using a generative model, comprising:
an instruction data store for storing computer-readable instructions; and
a processing system for executing the computer-readable instructions in the data store, to perform operations including:
receiving a query;
tokenizing the query into a tokenized query;
encoding the tokenized query into embedding information using a language model;
mapping the embedding information into a reduced-size vocabulary of tokens from which the response will be constructed, the reduced-size vocabulary of tokens being selected from a larger target vocabulary of tokens;
constructing a part of the response based on a particular group of ranked tokens, the particular group of ranked tokens being selected from the reduced-size vocabulary of tokens; and
upon producing all parts of the response, generating an output based on the response.

12. The computing of claim 11, wherein the larger target vocabulary of tokens includes at least some plural-word tokens, each of the plural-word tokens including a sequence of two or more words.

13. The computing system of claim 11,
wherein the embedding information includes a vocabulary-guiding embedding and a sequence of response-part embeddings,
wherein the mapping includes producing the reduced-size vocabulary of tokens based on the vocabulary-guiding embedding, and
wherein the method further includes identifying the particular group of ranked tokens based on a particular response-part embedding in the sequence of response-part embeddings.

14. The computing system of claim 13, wherein the mapping comprises:
identifying a set of cluster vectors that are closest to the vocabulary-guiding embedding in a vector space;
identifying clusters of token parameter vectors that are closest to the respective cluster vectors in the vector space, the clusters of token parameter vectors being associated with respective clusters of tokens; and
identifying the reduced-size vocabulary of tokens by forming a union of the clusters of tokens.

15. The computing system of claim 13, wherein the particular group of ranked tokens associated with the particular response-part embedding is identified by finding tokens in the reduced-size vocabulary of tokens having token parameter vectors that are closest to the particular response-part embedding in a vector space.

16. The computing system of claim 13, wherein the constructing is performed using a beam search process, in which selection of the part of the response is constrained by the particular group of ranked tokens associated with the particular response-part embedding.

17. The computing system of claim 13, wherein the operations further include:
identifying plural groups of ranked tokens, the plural groups of ranked tokens being selected from the reduced-size vocabulary of tokens based on the respective response-part embeddings, the particular group of ranked tokens being one of the plural groups of ranked tokens, and
wherein the parts of the response are generated non-autoregressively in a single pass based on the plural groups of ranked tokens.

18. The computing system of claim 11, wherein the parts of the response are generated autoregressively in plural passes.

19. The computing system of claim 11,
wherein the response expresses one or more document identifiers,
wherein the operations further comprise using the one or more document identifiers to access one or more documents that are associated with the one or more document identifiers, and
wherein the output that is generated includes information regarding the one or more documents.

20. A computer-readable storage medium for storing computer-readable instructions, a processing system executing the computer-readable instructions to perform operations, the operations comprising:
receiving a query;
tokenizing the query into a tokenized query;
encoding the tokenized query into a vocabulary-guiding embedding and a sequence of response-part embeddings;
mapping the vocabulary-guiding embedding into a reduced-size vocabulary of tokens, the reduced-size vocabulary of tokens being selected from a larger target vocabulary of tokens from which a response will be constructed, wherein the larger target vocabulary of tokens includes at least some plural-word tokens, each of the plural-word tokens including a sequence of two or more words;
identifying a particular group of ranked tokens associated with a particular response-part embedding in the sequence of response-part embeddings, the particular group of ranked tokens being selected from the reduced-size vocabulary of tokens;
constructing a part of a document identifier based on the particular group of ranked tokens; and
upon producing all parts of the document identifier, accessing at least one document associated with the document identifier.
